(19) United States
(12) Patent Application Publication
(10) Pub. No.: US 2026/0155843 A1
(43) Pub. Date: Jun. 4, 2026

(54) FREQUENCY MIXING CHIP, FREQUENCY MIXING METHOD, SIGNAL PROCESSING CHIP AND SIGNAL MONITORING SYSTEM

(71) Applicant: HANGZHOU GEO-CHIP TECHNOLOGY CO., LTD., Hangzhou (CN)

(72) Inventors: Ruili WU, Hangzhou (CN); Chun Geik TAN, San Diego, CA (US); Wai-Tat WONG, Hangzhou (CN); Xiaoping JIAO, Hangzhou (CN); Yong XIE, Hangzhou (CN)

(21) Appl. No.: 19/305,004

(22) Filed: Aug. 20, 2025

(30) Foreign Application Priority Data
Dec. 4, 2024 (CN) 202411776033.5
Dec. 25, 2024 (CN) 202411929568.1
Jan. 26, 2025 (CN) 202510125363.6
Mar. 11, 2025 (CN) 202520414028.3

(51) Int. Cl. H04B 1/00

(52) U.S. Cl. CPC H04B 1/0057; H04B 1/0075

(57) ABSTRACT

The present disclosure provides a frequency mixing chip and a monitoring device. The frequency mixing chip comprises an internal local oscillator, a multiplexer, and a mixer. The internal local oscillator is configured to generate a first local oscillator signal based on a reference clock signal. The multiplexer has a first input terminal for receiving a second local oscillator signal, a second input terminal for receiving the first local oscillator signal, and an output terminal for outputting a mixing signal. The mixer is configured to mix a signal to be frequency-shifted with the mixing signal, thereby generating a frequency-shifted signal for signal power monitoring. A monitoring device provided with this chip can achieve optimized configuration of wireless channels by detecting wireless communication signals across all frequency bands, thereby enabling lower-cost configuration and signal monitoring, and higher-quality and more efficient signal coverage.

### CROSS-REFERENCE TO RELATED PATENT APPLICATION

This application claims the benefits of and priorities to Chinese Patent Application No. 202411776033.5 filed on Dec. 4, 2024, Chinese Patent Application No. 202411929568.1 filed on Dec. 25, 2024, Chinese Patent Application No. 202510125363.6 filed on Jan. 26, 2025, and Chinese Patent Application No. 202520414028.3 filed on Mar. 11, 2025, the entire disclosures of which are incorporated by reference herein.

### TECHNICAL FIELD

The present disclosure relates to the technical field of signal processing, and specifically to chips, devices, and methods for signal monitoring. More specifically, the present disclosure relates to a frequency mixing chip, a monitoring device including the same, a signal monitoring method and apparatus based on frequency-shifting technology, as well as a signal processing chip and a signal monitoring system.

### BACKGROUND

This section is intended to provide background or context for the implementations of the present disclosure as set forth in claims. What is described herein is not admitted as prior art merely by virtue of its inclusion in this section.

In signal detection devices, such as those for antenna signals, power detection apparatuses measure received radio frequency (RF) signal power levels. The power detection apparatuses are critical for making communication system performance, as signal power directly affects signal coverage, quality, and reliability.

Conventional signal detection devices typically only support detection of antenna signals within a single frequency band by each of power detection apparatuses therein on a one-to-one basis, so that a single device cannot monitor antenna signals across multiple frequency bands.

Additionally, indoor distributed antenna monitoring device is key technical equipment for monitoring and managing indoor distributed antenna systems, which is widely used in residential communities, office buildings, large shopping malls, and other areas. It can detect whether various indoor distributed antenna nodes are abnormal or faulty in real-time based on received signal measurement information to monitor the working status of indoor distributed antennas in real-time.

However, conventional indoor distributed systems employ a one-to-one monitoring approach for signals from individual indoor distributed antenna paths, which suffers from lower precision and higher deployment costs, and crucially, susceptibility to inter-frequency interference that degrades monitoring quality.

Therefore, how to achieve lower costs while avoiding inter-frequency interference to improve indoor distribution monitoring quality is an urgent problem to be solved.

Furthermore, with the advancement of wireless communication technology, various network demands within buildings can be met. To achieve comprehensive network coverage, the application of passive signal monitoring systems plays a very important role.

To ensure the normal operation of a passive signal monitoring system, monitoring device is typically required in related technologies to monitor corresponding signal frequency bands.

However, most existing monitoring devices perform one-to-one monitoring of signals, no single monitoring device can monitor frequency points and bands other than the target frequency point, resulting in low monitoring accuracy and signal quality. Moreover, they require separate deployment, leading to high deployment costs.

### SUMMARY

In view of the problems in the prior art mentioned above, a frequency mixing chip and a monitoring device are proposed to enable accurate detection of wireless communication signals across all frequency bands.

In view of the problems in the prior art mentioned above, a signal monitoring method and apparatus based on frequency-shifting technology are also proposed to avoid inter-frequency interference with lower deployment costs, thereby improving indoor distribution monitoring quality.

In view of the problems in the prior art mentioned above, a signal processing chip and a signal monitoring system are also proposed to achieve signal monitoring across all frequency bands through baseband demodulation processing, thereby significantly improving monitoring accuracy and signal quality, with simpler deployment and higher integration.

In view of the problems in the prior art mentioned above, a signal monitoring system is also proposed to achieve signal monitoring across all frequency bands, significantly improving monitoring accuracy, with lower deployment costs.

The present disclosure provides the following solutions.

In a first aspect, the present disclosure provides a frequency mixing chip, at least including an internal local oscillator, a multiplexer, and a mixer, where
the internal local oscillator is configured to generate a first local oscillator signal based on a reference clock signal;
the multiplexer has a first input terminal for receiving a second local oscillator signal, a second input terminal for receiving the first local oscillator signal, and an output terminal for outputting a mixing signal; and
the mixer is configured to mix a signal to be frequency-shifted with the mixing signal, thereby generating a frequency-shifted signal for signal power monitoring.

In some possible embodiments, the mixer is configured as a dual-channel mixer.

In some possible embodiments, the dual-channel mixer includes a first mixer and a second mixer, where
the first mixer has a first input terminal for receiving the signal to be frequency-shifted, a second input terminal for receiving the mixing signal, and an output terminal for outputting the frequency-shifted signal; and
the second mixer has a first input terminal for receiving the signal to be frequency-shifted, a second input terminal for receiving the mixing signal, and an output terminal for outputting the frequency-shifted signal.

In some possible embodiments, the dual-channel mixer further includes a first amplifier and a second amplifier, where
the first amplifier has a first terminal connected to a first output terminal of the multiplexer, and a second terminal connected to the second input terminal of the first mixer; and
the second amplifier has a first terminal connected to a second output terminal of the multiplexer, and a second terminal connected to the second input terminal of the second mixer.

In some possible embodiments, the frequency mixing chip further includes a controller configured to control start/stop of the frequency mixing chip.

In some possible embodiments, the frequency mixing chip is applicable to an indoor distributed signal detection device.

In a second aspect, the present disclosure provides a monitoring device, having the aforesaid frequency mixing chip integrated therein, where the frequency mixing chip has an output terminal connected to an input terminal of a power detection apparatus of the monitoring device.

In some possible embodiments, the monitoring device further includes a switch module connected between the frequency mixing chip and an antenna.

In some possible embodiments, the monitoring device further includes a data transmission module and a master control module, where
the master control module is configured to receive a detection result sent by the power detection apparatus and send the detection result to the data transmission module; and
the data transmission module is configured to transmit the detection result to a monitoring platform via the switch module and the antenna.

In some possible embodiments, the monitoring device further includes a power supply module, where
the power supply module is configured to supply power to the switch module, the frequency mixing chip, the data transmission module, and the power detection module; and
the master control module is configured to control start/stop of the power supply module.

The frequency mixing chip according to the present disclosure, when applied to an antenna signal detection device, can convert an input signal to be frequency-shifted into a frequency-shifted signal in a target frequency band, allowing the power detection apparatus to directly perform power detection on the frequency-shifted signal, thereby enabling the signal detection device to accurately detect wireless communication signals across all frequency bands. A monitoring device provided with this chip can achieve optimized configuration of wireless channels by detecting wireless communication signals across all frequency bands, thereby enabling lower-cost configuration and signal monitoring, and higher-quality and more efficient signal coverage.

In a third aspect, the present disclosure provides a signal monitoring method based on frequency-shifting technology, including:
receiving a signal of frequency band under test;
determining a target frequency band and a target local oscillator signal based on an interference metric of a mixed signal generated from an interference frequency band signal and the target local oscillator signal relative to the target frequency band;
outputting a frequency-shifted signal within the target frequency band by mixing the target local oscillator signal with the signal of frequency band under test; and
monitoring the frequency-shifted signal.

Preferably, the method further includes making the interference metric below a preset threshold.

Preferably, determining the target frequency band and the target local oscillator signal based on the interference metric includes making the mixed signal generated from the interference frequency band signal and the target local oscillator signal fall outside the target frequency band.

Preferably, determining the target frequency band and the target local oscillator signal based on the interference metric includes: determining the target frequency band; determining a plurality of candidate local oscillator frequency points capable of frequency-shifting the signal of frequency band under test to the target frequency band; determining a mixed signal generated from the interference frequency band signal and a local oscillator signal corresponding to each candidate local oscillator frequency point; determining a corresponding interference metric by determining a proportion of the mixed signal corresponding to each candidate local oscillator frequency point falling into the target frequency band; and determining the target local oscillator signal based on the interference metric corresponding to each candidate local oscillator frequency point.

Preferably, a local oscillator signal corresponding to a candidate local oscillator frequency point with a lowest interference metric and/or with an interference metric below a preset threshold is determined as the target local oscillator signal.

Preferably, determining the interference metric includes: calculating according to a preset formula, FL=m*LO+n*RF, a frequency range where the interference frequency band signal resides after frequency-shifting; and determining the interference metric by comparing the frequency range with the target frequency band, where RF denotes a frequency of the interference frequency band signal, LO denotes a frequency point of the local oscillator signal for frequency-shifting, m denotes a variable positive integer value, n denotes a variable integer value, and FL denotes a frequency of the frequency-shifted interference frequency band signal.

Preferably, the interference frequency band signal falls within any one or more of the following frequency bands: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

The frequency band under test includes any one or more of the following: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

In a fourth aspect, the present disclosure provides a signal monitoring apparatus based on frequency-shifting technology, including:
a receiving module configured to receive a signal of frequency band under test;
a control module configured to determine a target frequency band and a target local oscillator signal based on an interference metric of a mixed signal generated from an interference frequency band signal and the target local oscillator signal relative to the target frequency band;
a frequency-shifting module configured to output a frequency-shifted signal within the target frequency band by mixing the target local oscillator signal with the signal of frequency band under test; and
a monitoring module configured to monitor the frequency-shifted signal.

Preferably, the control module is configured to make the interference metric below a preset threshold.

Preferably, the control module is configured to make the mixed signal generated from the interference frequency band signal and the target local oscillator signal fall outside the target frequency band.

Preferably, the control module is configured to: determine the target frequency band; determine a plurality of candidate local oscillator frequency points capable of frequency-shifting the signal of frequency band under test to the target frequency band; determine a mixed signal generated from the interference frequency band signal and a local oscillator signal corresponding to each candidate local oscillator frequency point; determine a corresponding interference metric by determining a proportion of the mixed signal corresponding to each candidate local oscillator frequency point falling into the target frequency band; and determine the target local oscillator signal based on the interference metric corresponding to each candidate local oscillator frequency point.

Preferably, the control module is configured to determine a local oscillator signal corresponding to a candidate local oscillator frequency point with a lowest interference metric and/or with an interference metric below a preset threshold as the target local oscillator signal.

Preferably, the control module is configured to: calculate according to a preset formula, FL=m*LO+n*RF, a frequency range where the interference frequency band signal resides after frequency-shifting; and determine the interference metric based on an overlap degree between the frequency range and the target frequency band, where RF denotes a frequency of the interference frequency band signal, LO denotes a frequency point of the local oscillator signal for frequency-shifting, m denotes a variable positive integer value, n denotes a variable integer value, and FL denotes a frequency of the frequency-shifted interference frequency band signal.

Preferably, the interference frequency band signal falls within any one or more of the following: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

One advantage of the above embodiments is as follows. When monitoring a signal of frequency band under test, a target frequency band and a target local oscillator signal for frequency-shifting the signal of frequency band under test to the target frequency band are first determined, the target local oscillator signal being a selected local oscillator signal that makes a mixed signal generated from the interference frequency band signal and the selected local oscillator signal have a relatively low interference metric relative to the target frequency band, and then the target local oscillator signal is mixed with the signal of frequency band under test to output a frequency-shifted signal for monitoring, thereby enabling the signal of frequency band under test to be frequency-shifted to any frequency band for monitoring while controlling frequency interference, thus achieving accurate monitoring across all frequency bands with lower costs.

In a fifth aspect, the present disclosure provides a signal processing chip including a data-driven baseband processor and a master control module, the data-driven baseband processor being constructed based on a Reduced Instruction Set Computing Verilog (RISC-V) open-source architecture, where
the data-driven baseband processor is configured to: process baseband signals, support Time Division Duplex (TDD) synchronization, provide an antenna address interface; and in response to a signal monitoring instruction for a signal monitoring system, receive a radio frequency (RF) signal sent by an RF transceiver, and transfer the RF signal to the master control module; and
the master control module is configured to control start/stop of the signal processing chip; and obtain signal parsing status for the signal monitoring system, the signal parsing status characterizing a signal monitoring result across all frequency bands.

In one possible implementation, when the RF transceiver is applied to a base station signal source connected to the signal monitoring system, the data-driven baseband processor is specifically configured to, in an environment where the signal monitoring system is located, detect a base station synchronization signal, perform baseband demodulation on a first RF signal sent by the base station signal source, and output a first baseband demodulated signal as well as a synchronization signal and a time slot indication signal.

In one possible implementation, when the RF transceiver is applied to a user equipment connected to the signal monitoring system, the data-driven baseband processor is specifically configured to, in the environment where the signal monitoring system is located, perform baseband demodulation on a second RF signal sent by the user equipment, and output a second baseband demodulated signal for performing signal parsing for the signal monitoring system.

In one possible implementation, when configured with a plurality of antennas, the signal processing chip further includes a frequency mixing chip configured to determine signal power obtained from user equipment and/or antenna transmission, perform mixing on a signal of frequency band to be monitored, and output the mixed signal to the master control module.

In one possible implementation, the signal processing chip further includes an expandable interface and an auxiliary function module, where the expandable interface is arranged on a bus and in signal transmission with both the data-driven baseband processor and the master control module, and the auxiliary function module is in signal transmission with the master control module via a peripheral bus and configured to support control logic of the master control module.

In one possible implementation, the auxiliary function module includes one or more of the following components:
a debug controller for port debugging;
a clock manager for synchronizing system clocks and internal clocks;
a general-purpose input/output port controller for input/output interaction control;
an asynchronous serial interface controller for receiving system instructions and transmitting data;
a controller for external Flash memory control;
a controller for enabling a low-power power-saving mode; and
a watchdog timer for implementing timing functions.

In a sixth aspect, the present disclosure also provides a signal monitoring system, including the signal processing chip according to any one of the fifth aspect and its various implementations, where the signal processing chip is configured to perform signal monitoring for the signal monitoring system to determine the signal monitoring result across all frequency bands.

In one possible implementation, the signal monitoring system further includes a receiving antenna, a frequency shifter, a power management unit (PMU), and a network communication module, the frequency shifter, the signal processing chip, and the network communication module being sequentially connected, where
the frequency shifter is configured to determine signal power obtained from user equipment and/or antenna transmission, perform mixing on a signal of frequency band to be monitored, and transfer the mixed signal to the signal processing chip;
the signal processing chip is configured to, during an enabling control process of the power management unit, determine a signal monitoring result based on the mixed signal, and transmit the signal monitoring result to the network communication module; and
the network communication module is configured to report the signal monitoring result generated by the signal processing chip to a cloud.

In one possible implementation, the network communication module is further configured to report antenna monitoring information of the receiving antenna to the cloud.

According to the above signal processing chip and signal monitoring system, the data-driven baseband processor in the signal processing chip processes baseband signals, supports TDD synchronization, provides an antenna address interface, and receives, in response to a signal monitoring instruction of the signal monitoring system, an RF signal sent by an RF transceiver; the master control module controls the start/stop of the signal processing chip and obtains signal parsing status for the signal monitoring system, which characterizes the signal monitoring result across all frequency bands. It is evident that the present disclosure integrates components such as the data-driven baseband processor (based on the RISC-V open-source architecture) and master control module into the signal processing chip, achieving high integration, thus can achieve corresponding signal monitoring functions via simple deployment, and enables baseband demodulation processing of RF signals using the RISC-V open-source architecture, significantly improving the accuracy and signal quality of monitoring across all frequency bands.

In a seventh aspect, the present disclosure also provides a signal monitoring system including an Internet of Things (IoT) communication module and one or more slave devices, the IoT communication module including a first wireless microcontroller (MCU), and each slave device including a second wireless MCU and communicating with the IoT communication module via a wireless connection between the second wireless MCU and the first wireless MCU, where
the slave device at least includes a baseband signal processor capable of processing baseband signals, and is configured to perform mixing on an RF signal received by a frequency shifter and transfer the mixed signal to the baseband signal processor;
the slave device is configured to, in response to a signal monitoring instruction issued by the IoT communication module, based on an RF signal sent by user equipment or a base station signal source, determine a signal monitoring result within a frequency band indicated by the signal monitoring instruction, and transmit the signal monitoring result to the IoT communication module; and
the IoT communication module is configured to report the signal monitoring result to a cloud server.

In one possible implementation, the IoT communication module further includes a first power management unit (PMU) connected to the first wireless MCU, where
the first PMU is configured to place the first wireless MCU in a powered-on startup state; and
the first wireless MCU is configured to, in the powered-on startup state, receive the signal monitoring result sent by at least one of the slave devices.

In one possible implementation, the IoT communication module further includes a network communication module connected to the first PMU and the first wireless MCU, where
the first PMU is further configured to place the network communication module in a powered-on startup state;
the first wireless MCU is further configured to transmit the received at least one signal monitoring result to the network communication module; and
the network communication module is configured to, in the powered-on startup state, upload the obtained at least one signal monitoring result to the cloud server.

In one possible implementation, the slave device further includes a receiving antenna, a second power management unit (PMU), and the frequency shifter, the frequency shifter, the baseband signal processor, and the second wireless MCU being sequentially connected, where
the frequency shifter is specifically configured to determine signal power obtained by the receiving antenna receiving signals from user equipment and/or the base station signal source, perform mixing on the received RF signal, and transfer the mixed signal to the baseband signal processor;
the baseband signal processor is specifically configured to, when the second PMU is in a powered-on enabled state, determine the signal monitoring result based on the mixed signal, and transmit the signal monitoring result to the second wireless MCU; and
the second wireless MCU is specifically configured to transmit the signal monitoring result generated by the baseband signal processor to the IoT communication module.

In one possible implementation, the baseband signal processor includes a data-driven baseband processor and a master control module, the data-driven baseband processor being constructed based on a Reduced Instruction Set Computing Verilog (RISC-V) open-source architecture, where
the data-driven baseband processor is configured to process baseband signals, support Time Division Duplex (TDD) synchronization, provide an antenna address interface; and in response to the signal monitoring instruction issued by the IoT communication module, receive the RF signal sent by the user equipment or the base station signal source, and transfer the RF signal to the master control module; and
the master control module is configured to control start/stop of the baseband signal processor, and obtain the signal monitoring result within the frequency band indicated by the signal monitoring instruction.

In one possible implementation, a frequency band of the RF signal includes one or more of the following: 2G, 3G, 4G, 5G, and 6G.

In one possible implementation, the baseband signal processor further includes an expandable interface and an auxiliary function module, where the expandable interface is arranged on a bus and in signal transmission with both the data-driven baseband processor and the master control module, and the auxiliary function module is in signal transmission with the master control module via a peripheral bus and configured to support control logic of the master control module.

In one possible implementation, the auxiliary function module includes one or more of the following components:
a debug controller for port debugging;
a clock manager for synchronizing system clocks and internal clocks;
a general-purpose input/output port controller for input/output interaction control;
an asynchronous serial interface controller for receiving system instructions and transmitting data;
a controller for external Flash memory control;
a controller for enabling a low-power power-saving mode; and
a watchdog timer for implementing timing functions.

In one possible implementation, the plurality of slave devices are disposed on nodes of a multi-level distributed network, and configured to determine whether a corresponding node has malfunctioned based on the signal monitoring result.

In one possible implementation, the multi-level distributed network includes a base station signal source and distributed network equipment at various levels.

According to the above signal monitoring system, the slave device included therein is configured to, based on the signal monitoring instruction issued by the IoT communication module, determine the signal monitoring result within the frequency band indicated by the signal monitoring instruction based on the RF signal sent by the user equipment or the base station signal source and perform mixing based on the target frequency band; transmit the signal monitoring result to the IoT communication module; and the IoT communication module is configured to report the signal monitoring result to the cloud server. It is evident that the present disclosure achieves signal monitoring across all frequency bands through a one-to-many master-slave system architecture, significantly improving monitoring accuracy, and reduces deployment costs.

Other advantages of the present disclosure will be explained in more detail in conjunction with the following description and drawings.

It should be understood that the above description is a summary of the technical solutions of the present disclosure only for the purpose of facilitating a better understanding of the technical means of the present disclosure so that the disclosure can be implemented according to the description in the specification. Specific embodiments of the present disclosure are given below to render the above and other objects, features and advantages of the present disclosure more clear.

### BRIEF DESCRIPTION OF THE DRAWINGS

By reading the detailed description of the exemplary embodiments below, a person of ordinary skill in the art will understand the advantages and benefits described herein as well as other advantages and benefits. The drawings are only for the purpose of illustrating the exemplary embodiments and are not considered as limiting the present disclosure. Moreover, throughout the drawings, the same reference numerals indicate the same parts. In the drawings:

FIG. 1 is a schematic diagram of a frequency mixing chip according to an embodiment of the present disclosure;

FIG. 2 is a schematic diagram of a dual-channel frequency mixing chip according to an embodiment of the present disclosure;

FIG. 3a is a pin diagram of a dual-channel frequency mixing chip according to an embodiment of the present disclosure;

FIG. 3b is a pin comparison table for the dual-channel frequency mixing chip shown in FIG. 3a;

FIG. 4 is a schematic diagram of a monitoring device according to an embodiment of the present disclosure;

FIG. 5 is another schematic diagram of a monitoring device according to an embodiment of the present disclosure;

FIG. 6 is a flowchart of a signal monitoring method based on frequency-shifting technology according to an embodiment of the present invention;

FIG. 7 is another flowchart of a signal monitoring method based on frequency-shifting technology according to an embodiment of the present invention;

FIG. 8 is a structural diagram of a signal monitoring apparatus based on frequency-shifting technology according to an embodiment of the present invention;

FIG. 9 is a structural diagram of a signal monitoring system chip based on frequency-shifting technology according to an embodiment of the present invention;

FIG. 10 shows a module diagram of a signal processing chip according to an embodiment of the present disclosure;

FIG. 11 shows a pin diagram of a signal processing chip according to an embodiment of the present disclosure;

FIG. 12 shows a framework diagram of another signal processing chip according to an embodiment of the present disclosure;

FIG. 13 shows a system architecture diagram of a signal monitoring system according to an embodiment of the present disclosure;

FIG. 14 shows a module diagram of a signal monitoring system according to an embodiment of the present disclosure;

FIG. 15 shows a system framework diagram of a signal monitoring system according to an embodiment of the present disclosure;

FIG. 16 shows a module diagram of a baseband signal processor in the signal monitoring system according to an embodiment of the present disclosure;

FIG. 17 shows an application diagram of a signal monitoring system according to an embodiment of the present disclosure.

In the drawings, the same or corresponding reference numerals indicate the same or corresponding parts.

### DETAILED DESCRIPTION

The exemplary embodiments of the present disclosure will be described in more detail below with reference to the drawings. Although the exemplary embodiments of the present disclosure are shown in the drawings, it should be understood that the present disclosure can be implemented in various forms and should not be limited by the embodiments described herein. Rather, these embodiments are provided to facilitate more thorough understanding of the present disclosure, so that the scope of the disclosure could be fully conveyed to a person of ordinary skill in the art.

In the description of the embodiments of the present disclosure, it should be understood that terms such as “including” or “having” are intended to indicate the presence of features, numbers, steps, behaviors, components, parts, or combinations thereof disclosed in this specification, and are not intended to exclude the possibility of the presence of one or more other features, numbers, steps, behaviors, components, parts, or combinations thereof. The terms such as “first” and “second” are for descriptive purposes only and are not intended to be construed as indicating or implying a relative importance or implicitly indicating the number of technical features indicated. Hence, features defined by “first” or “second” may explicitly or implicitly include one or more features. In the description of the embodiments of the present disclosure, “a plurality of” means two or more in number, unless otherwise specified.

Unless otherwise specified, “/” refers to “or”. For example, A/B may indicate A or B. In this specification, the term “and/or” merely describes the association relationship between the associated objects and indicates that there may be three relationships. For example, A and/or B may indicate three cases where only A exists, both A and B exist, and only B exists. For convenience of description, spatial relationship terms such as “below,” “lower,” “upper,” “above,” etc., may be used herein to describe the relationship of one element or feature to other elements or features as shown in the drawings. It should be understood that these spatial relationship terms are intended to encompass orientations of the device in use or operation other than the orientations depicted in the drawings.

Additionally, it should be noted that the embodiments in the present disclosure and the features in the embodiments can be combined with each other without conflict. The present disclosure will be described in detail below with reference to the drawings and in conjunction with the embodiments.

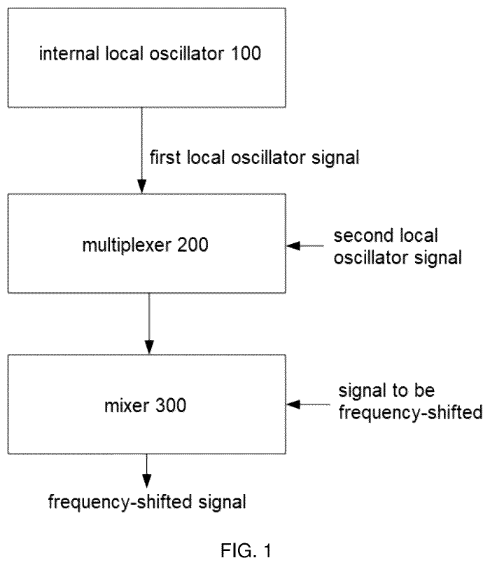

FIG. 1 shows a schematic diagram of a frequency mixing chip according to an embodiment of the present disclosure.

As shown in FIG. 1, the frequency mixing chip according to this embodiment includes at least an internal local oscillator 100, a multiplexer 200, and a mixer 300.

The internal local oscillator 100 is configured to generate a first local oscillator signal based on a reference clock signal.

The multiplexer 200 has a first input terminal for receiving a second local oscillator signal, a second input terminal for receiving the first local oscillator signal, and an output terminal for outputting a mixing signal.

The mixer 300 is configured to mix a signal to be frequency-shifted with the mixing signal, thereby generating a frequency-shifted signal for signal power monitoring.

It should be noted that the frequency mixing chip according to this embodiment is applicable to indoor distributed signal detection devices or other signal detection devices, which is not limited herein. The multiplexer in this embodiment may be configured to receive the first local oscillator signal and the second local oscillator signal, and may also be configured to receive other types of local oscillator signals, which is not limited herein. The multiplexer in this embodiment can select different local oscillator signals as mixing signals for output, according to specific mixing needs, enabling the signal detection device to accurately detect wireless communication signals across all frequency bands.

Therefore, the frequency mixing chip according to the present disclosure, when applied to an antenna signal detection device, can output different mixing signals through the multiplexer with the internal local oscillator, and thus can convert an input signal to be frequency-shifted into a frequency-shifted signal in a target frequency band using the outputted mixing signal, allowing the power detection apparatus to directly perform power detection on the frequency-shifted signal, thereby enabling the signal detection device to accurately detect wireless communication signals across all frequency bands.

As a possible implementation, the mixer according to this embodiment may be configured as a dual-channel mixer configured to mix two input differential signals with the mixing signal to generate two frequency-shifted signals. An example is provided below to specifically introduce the mixer according to this embodiment.

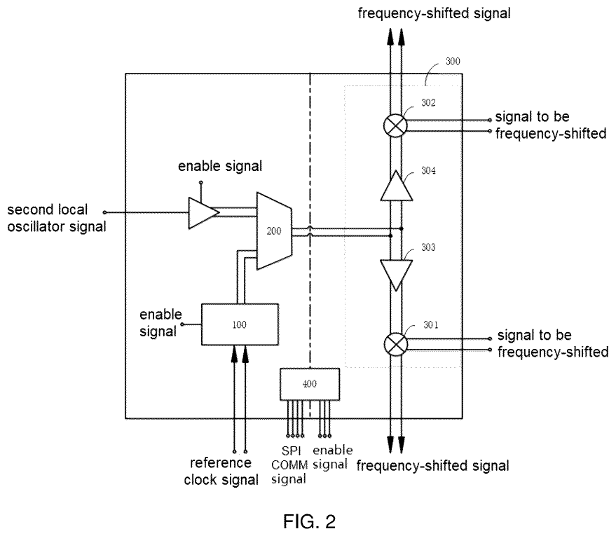

In this embodiment, as shown in FIG. 2, the dual-channel mixer may include a first mixer 301 and a second mixer 302. The first mixer 301 has a first input terminal for receiving the signal to be frequency-shifted, a second input terminal for receiving the mixing signal, and an output terminal for outputting the frequency-shifted signal. The second mixer 302 has a first input terminal for receiving the signal to be frequency-shifted, a second input terminal for receiving the mixing signal, and an output terminal for outputting the frequency-shifted signal.

As shown in FIG. 2, the dual-channel mixer according to this embodiment further includes a first amplifier 303 and a second amplifier 304. The first amplifier 303 has a first terminal connected to a first output terminal of the multiplexer 200, and a second terminal connected to the second input terminal of the first mixer 301. The second amplifier 304 has a first terminal connected to a second output terminal of the multiplexer 200, and a second terminal connected to the second input terminal of the second mixer 302.

As a possible implementation, the frequency mixing chip according to this embodiment may further include a controller 400. The controller 400 according to this embodiment is configured to control the start/stop of the frequency mixing chip.

The frequency mixing chip according to the present disclosure is applicable to signal detection devices, especially suitable for antenna signal detection, which can output different mixing signals through the multiplexer with the internal local oscillator, and thus can convert an input signal to be frequency-shifted into a frequency-shifted signal in a target frequency band using the outputted mixing signal, allowing the power detection apparatus to directly perform power detection on the frequency-shifted signal, thereby enabling the signal detection device to accurately detect wireless communication signals across all frequency bands. A monitoring device provided with this chip can achieve optimized configuration of wireless channels by detecting wireless communication signals across all frequency bands, thereby enabling lower-cost configuration and signal monitoring, and higher-quality and more efficient signal coverage. The frequency mixing chip according to this embodiment is simple to deploy and has cost advantages, and can also be used to detect whether someone is illegally using some controlled frequency bands by detecting various frequency bands.

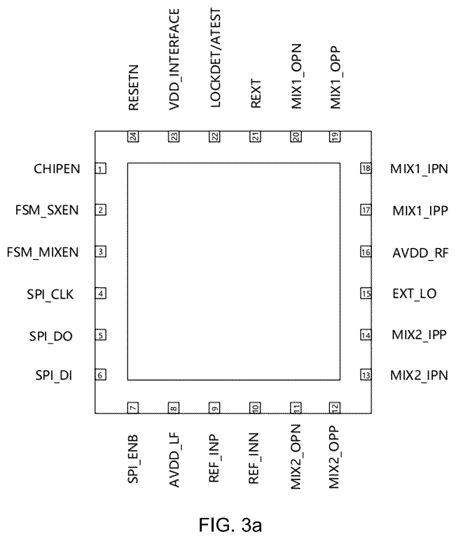

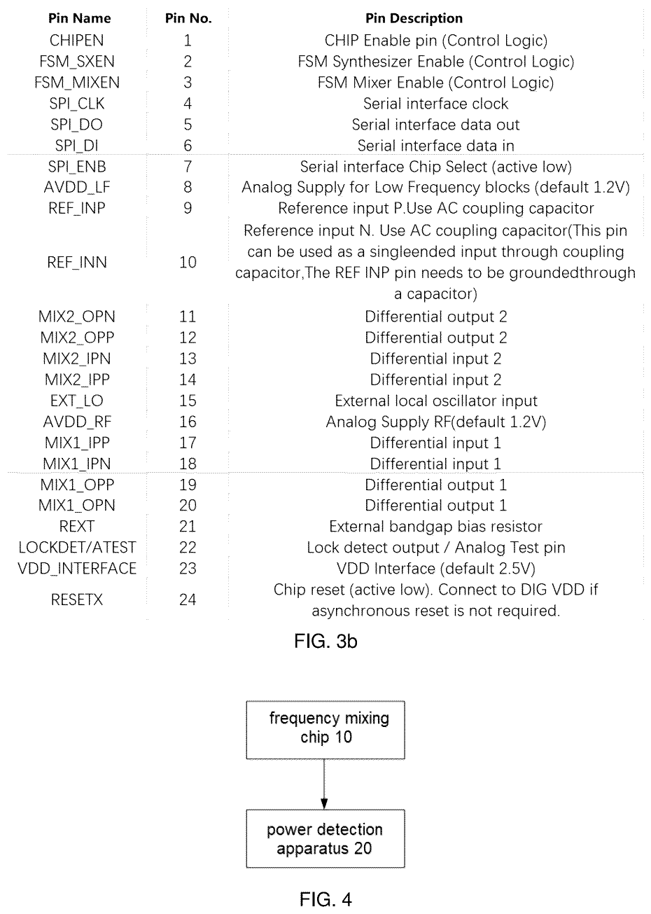

FIG. 3a is a pin diagram of a dual-channel frequency mixing chip according to an embodiment of the present disclosure, but this does not limit the scope of the solution. FIG. 3b is provided for explanation of the pins in FIG. 3a. The explanations in the table represent the general interpretation of pins in the RF field that should be known to a person of ordinary skill in the art.

Based on the frequency mixing chip according to the above embodiment, the present disclosure also provides a monitoring device.

As shown in FIG. 4, the monitoring device according to this embodiment includes a power detection apparatus 20 and the frequency mixing chip 10 described in the above embodiment.

The frequency mixing chip 10 has an output terminal connected to an input terminal of the power detection apparatus 20; and the power detection apparatus 20 is configured to perform power detection on wireless communication signals.

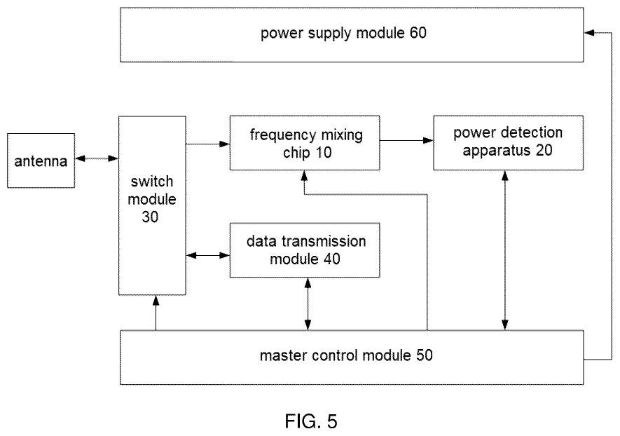

As a possible implementation, as shown in FIG. 5, the monitoring device according to this embodiment further includes a switch module 30, a data transmission module 40, a master control module 50, and a power supply module 60.

The power supply module 60 according to this embodiment is configured to supply power to the switch module 30, the frequency mixing chip 10, the data transmission module 40, and the power detection module. The master control module 50 is configured to receive the detection result sent by the power detection apparatus 20 and provide the detection result to the data transmission module 40. In practical applications, after initial power-on, the master control module 50 may remain in a powered-on state, and control the power-on/power-off status of the switch module 30, the frequency mixing chip 10, the data transmission module 40, and the power detection module by controlling the start/stop of the power supply module 60.

The switch module 30 according to this embodiment is connected between the frequency mixing chip 10 and an antenna, and configured to control the signal path between the frequency mixing chip 10 and the antenna. During normal operation of the monitoring device in this embodiment, under the control of the master control module 50, the switch module 30 may be turned on, the frequency mixing chip 10 may be activated and configured with the required detection frequency point, and the power detection module may be activated. Then, the antenna signal entering through the antenna may be frequency-shifted by the frequency mixing chip 10 and undergo detection by the power detection module. The data transmission module 40 according to this embodiment may transmit the detection result to a monitoring platform via the switch module 30 and the antenna. After receiving the detection result, if the monitoring platform determines that the monitoring device has a new requirement, it may issue an instruction according to the new requirement, which is finally conveyed to the master control module 50 via the antenna, switch module 30, and data transmission module 40. The master control module 50 may output a control signal according to the instruction issued by the platform.

It should be noted that the monitoring device in this embodiment can convert the input signal to be frequency-shifted into a frequency-shifted signal in a target frequency band through the frequency mixing chip, so that the power detection apparatus can then directly perform power detection on the frequency-shifted signal, enabling the monitoring device to accurately detect wireless communication signals across all frequency bands. The monitoring device can achieve optimized configuration of wireless channels by detecting wireless communication signals across all frequency bands, thereby enabling lower-cost configuration and signal monitoring, and higher-quality and more efficient signal coverage.

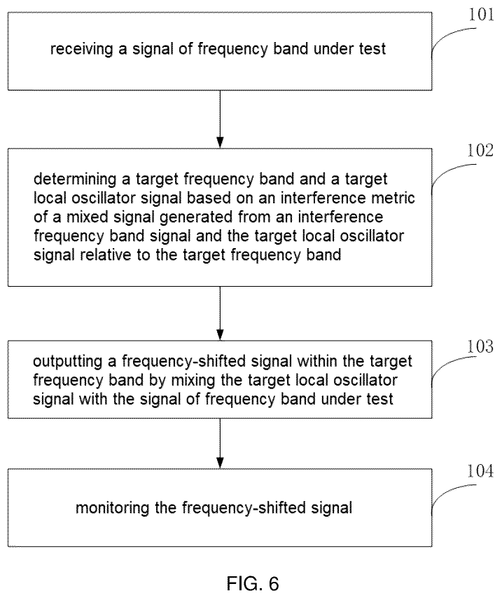

FIG. 6 is a flowchart of a signal monitoring method based on frequency-shifting technology according to an embodiment of the present invention. In this process, from a device perspective, the execution subject may be one or more electronic devices; from a program perspective, the execution subject may correspondingly be a program loaded on these electronic devices, especially the monitoring device corresponding to FIGS. 1-5, which implements the frequency mixing method of this embodiment to convert the input signal to be frequency-shifted into a frequency-shifted signal in a target frequency band through the configuration of the frequency mixing chip, allowing the power detection apparatus to directly perform power detection on the frequency-shifted signal.

As shown in FIG. 6, the method according to this embodiment may include the following steps.
101: a signal of frequency band under test is received.

The signal of frequency band under test refers to a signal within a frequency band to be tested in the received RF signal. For example, when it is desired to monitor the N41 frequency band (covering the frequency range 2515-2675 MHz), the N41 frequency band signal in the RF signal is obtained as the signal of frequency band under test.
102: a target frequency band and a target local oscillator signal is determined based on an interference metric of a mixed signal generated from an interference frequency band signal and the target local oscillator signal relative to the target frequency band.

The target frequency band refers to a frequency band to which the signal of frequency band under test is desired to be frequency-shifted. Specifically, it may be a suitable frequency band determined as needed. The target local oscillator signal refers to a local oscillator signal used to frequency-shift the signal of frequency band under test to the target frequency band. Specifically, a frequency-shifted signal within the target frequency band can be generated by mixing the signal of frequency band under test with the target local oscillator signal. Using such a frequency-shifted signal as the monitoring object not only excludes interference signals to obtain accurate monitoring results but also, more importantly, enables monitoring of signals across all frequency bands.

The frequency band under test includes any one or more of the following: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

In a possible implementation, within the measurable range, any frequency band may be selected within the target frequency band for frequency-shifting the signal of frequency band under test, achieving accurate monitoring across all frequency bands.

The interference frequency band signal refers to a frequency band signal with significant interference signals or noise. The interference frequency band generally includes public network common frequency bands where there typically exist significant interference signals, easily leading to inaccurate monitoring.

In a possible implementation, the interference frequency band signal may fall within the 3G frequency band and/or its harmonic frequency band(s), 4G frequency band and/or its harmonic frequency band(s), 5G frequency band and/or its harmonic frequency band(s), and/or WiFi frequency band and/or its harmonic frequency band(s).

In a possible implementation, in the aforementioned step 102, a suitable target frequency band and a target local oscillator signal may be selected so that the interference metric of the mixed signal generated from the interference frequency band signals such as 3G, 4G, 5G, or WiFi signals or their harmonic signals and the target local oscillator signal relative to the target frequency band can be restricted to a low level.

In a possible implementation, in the aforementioned step 102, a suitable target frequency band and a target local oscillator signal may be selected so that the interference metric may be controlled to be below a preset threshold. For example, the frequency range of the mixed signal generated from the interference frequency band signal and each target local oscillator signal may be calculated; the value of the interference metric may be determined based on the proportion of this frequency range falling within the target frequency band; and the target frequency band and target local oscillator signal with a relatively low interference metric may be determined by comparing the interference metric value with the preset threshold.

In a possible implementation, in the aforementioned step 102, when higher monitoring accuracy is required, the mixed signal generated from the interference frequency band signal and the selected target local oscillator signal may be controlled to fall outside the target frequency band.

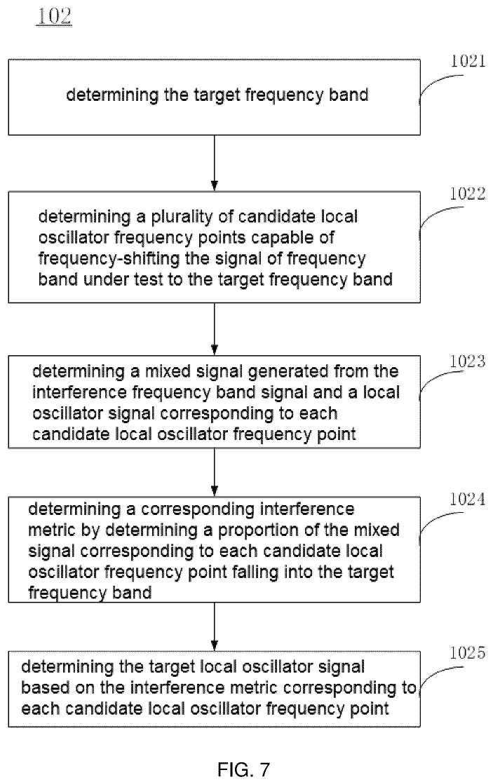

In a possible implementation, referring to FIG. 7, the aforementioned step 102 may further include the following steps.
1021: the target frequency band is determined, where the target frequency band may be freely selected.
1022: a plurality of candidate local oscillator frequency points capable of frequency-shifting the signal of frequency band under test to the target frequency band are determined.
1023: a mixed signal generated from the interference frequency band signal and the local oscillator signal corresponding to each candidate local oscillator frequency point is determined.
1024: a corresponding interference metric is determined by determining a proportion of the mixed signal corresponding to each candidate local oscillator frequency point falling into the target frequency band.
1025: the target local oscillator signal is determined based on the interference metric corresponding to each candidate local oscillator frequency point.

Specifically, the candidate local oscillator frequency point with the lowest interference metric and/or with an interference metric below the preset threshold may be determined, and its corresponding local oscillator signal is selected as the target local oscillator signal.

After selecting a suitable target frequency band and target local oscillator signal, the following steps are performed.
103: the target local oscillator signal is mixed with the signal of frequency band under test to output a frequency-shifted signal within the target frequency band.
104: the frequency-shifted signal is monitored.

Specifically, a power detection apparatus may be used to directly perform power detection on the frequency-shifted signal, achieving detection of the frequency band under test.

This embodiment is applicable to the monitoring device of the previous embodiment. For example, the aforementioned signal to be frequency-shifted may be the signal of frequency band under test in this embodiment, and the aforementioned mixing signal may be the target local oscillator signal determined in this embodiment.

Accordingly, the signal of frequency band under test can be converted into a frequency-shifted signal in the target frequency band for power detection. During the frequency-shifting process, a suitable target frequency band and target local oscillator signal can be selected to avoid or reduce the situation where the interference frequency band signal is also frequency-shifted into this target frequency band to cause frequency interference, enabling accurate monitoring across all frequency bands.

The following is a specific explanation in conjunction with a specific embodiment:

In one example, taking frequency-shifting a signal (to be monitored) in the frequency band ranging from 2515M to 2675M to a target frequency band 600M˜700M for detection as an example. It could be understood that due to the existence of interference frequency band signals, for detection of the signal to be monitored, interference from signals in public frequency bands (interference frequency band, such as 4G, 5G, Wi-Fi) and their harmonics to the target frequency band after frequency-shifting needs to be considered. For instance, the main frequency bands (bands) of 4G and 5G mobile networks for various operators are distributed within the following bands: B28/B8/B3/B39/B34/B1/B40/B77/B78/B79. Therefore, when determining the frequency point of the target local oscillator signal, it is desirable to calculate the degree of the mixing product of each frequency band signal and its harmonics with the local oscillator signal and its harmonics falling into the target frequency band 600M˜700M. For example, a preset formula FL=m*LO+n*RF may be used to calculate the frequency range where the interference frequency band signal resides after frequency-shifting. Here, RF denotes a frequency of the interference frequency band signal to be monitored, LO denotes the frequency point of the local oscillator signal for frequency-shifting, m denotes a variable positive integer value (that may be 1, 2, 3, . . . ), n denotes a variable integer value (that may be 1, −1, 2, −2, 3, −3, . . . ), and FL denotes the signal of the interference frequency band after frequency-shifting.

As verified by the applicant, if a local oscillator frequency point of 3115M is selected, the second harmonic of the first interference frequency band (1830M˜1880M) and the second interference frequency band (1880M˜1920M) mixed with the local oscillator 3115M fall into the monitoring range of the target frequency band (600M˜700M) with a strong signal strength, affecting the monitoring result; however, if a local oscillator frequency point of 1915M is selected instead, the extent of the mixing product of the interference frequency band signal and the local oscillator falling into the target frequency band (600M˜700M) range is very small and negligible, thus minimizing interference from other frequency band signals to the frequency band under test.

It should be noted that steps not described in detail in this embodiment may be referred to the description in the relevant steps in the embodiment shown in FIG. 6, which will not be repeated here.

Any process or method description in the flowchart or otherwise described herein can be understood as representing a module, segment, or portion of code that includes one or more executable instructions for implementing specified logical functions or steps of the process. The scope of the preferred embodiments of the present invention includes additional implementations in which functions may be performed not in the order shown or discussed, including in a substantially simultaneous manner or in the reverse order according to the functions involved, which could be understood by a person of ordinary skill in the art to which the embodiments of the present invention relate.

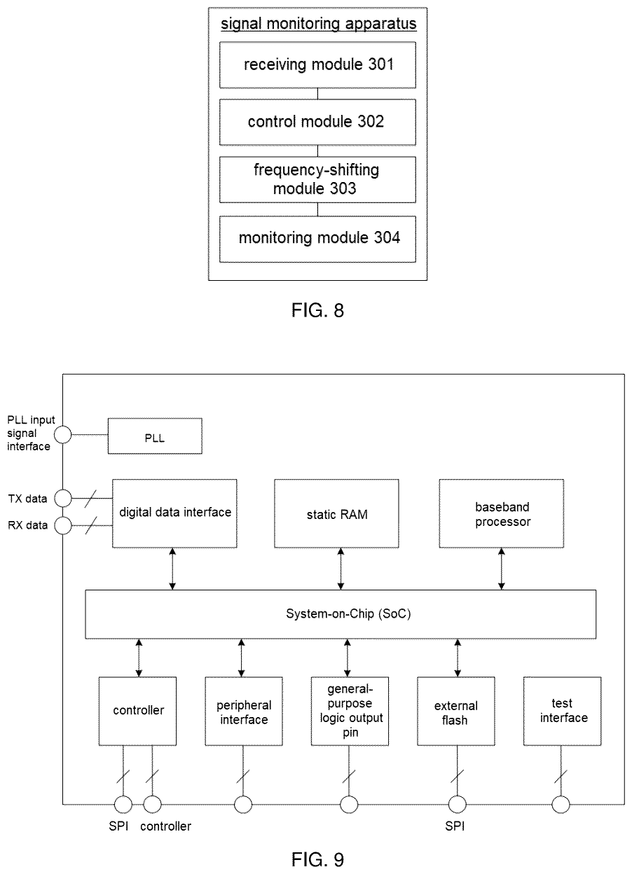

Based on the same technical concept, embodiments of the present invention also provide a signal monitoring apparatus based on frequency-shifting technology for executing the signal monitoring method based on frequency-shifting technology provided in any of the above embodiments. FIG. 8 is a schematic structural diagram of a signal monitoring apparatus based on frequency-shifting technology according to an embodiment of the present invention.

It should be noted that the monitoring device may be integrated into a System-on-Chip (SoC). Referring to FIG. 9, in some possible embodiments, it may be integrated into a high-performance, highly integrated 4G/5G baseband demodulation SoC based on the RISC-V architecture. This SoC may monolithically integrate an MCU, baseband processor, and on-chip SRAM, supporting a flexible and upgradable software-reconfigurable architecture. It may be widely used in 4G and 5G indoor distributed signal detection, repeater TDD synchronization, and customized 5G private networks such as satellite IoT applications.

Referring to FIG. 8, a signal monitoring apparatus based on frequency-shifting technology includes:
a receiving module 301 configured to receive a signal of frequency band under test;
a control module 302 configured to determine a target frequency band and a target local oscillator signal based on an interference metric of a mixed signal generated from an interference frequency band signal and the target local oscillator signal relative to the target frequency band;
a frequency-shifting module 303 configured to output a frequency-shifted signal within the target frequency band by mixing the target local oscillator signal with the signal of frequency band under test; and
a monitoring module 304 configured to monitor the frequency-shifted signal.

Preferably, the control module 302 is configured to determine the target frequency band and target local oscillator signal that make the interference metric below a preset threshold.

Preferably, the control module 302 is configured to determine the target frequency band and target local oscillator signal that make the mixed signal generated from the interference frequency band signal and the target local oscillator signal fall outside the target frequency band.

Preferably, the control module 302 is configured to: determine the target frequency band; determine a plurality of candidate local oscillator frequency points capable of frequency-shifting the signal of frequency band under test to the target frequency band; determine the mixed signal generated from the interference frequency band signal and a local oscillator signal corresponding to each candidate local oscillator frequency point; determine a corresponding interference metric by determining a proportion of the mixed signal corresponding to each candidate local oscillator frequency point falling into the target frequency band; and determine the target local oscillator signal based on the interference metric corresponding to each candidate local oscillator frequency point.

Preferably, the control module 303 is configured to determine a local oscillator signal corresponding to a candidate local oscillator frequency point with the lowest interference metric and/or with an interference metric below the preset threshold as the target local oscillator signal.

Preferably, the control module 303 is configured to: calculate according to a preset formula, FL=m*LO+n*RF, a frequency range where the interference frequency band signal resides after frequency-shifting; and determine the interference metric based on an overlap degree between the frequency range and the target frequency band, where RF denotes a frequency of the interference frequency band signal, LO denotes a frequency point of the local oscillator signal for frequency-shifting, m denotes a variable positive integer value, n denotes a variable integer value, and FL denotes a frequency of the frequency-shifted interference frequency band signal.

Preferably, the interference frequency band signal may fall within the 3G frequency band and/or its harmonic frequency band(s), 4G frequency band and/or its harmonic frequency band(s), 5G frequency band and/or its harmonic frequency band(s), and/or WiFi frequency band and/or its harmonic frequency band(s).

Preferably, the frequency band under test includes any one or more of the following: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

The target frequency band includes any one or more of the following: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

It should be noted that the apparatus in the embodiments of the present disclosure can implement each process of the foregoing method and achieve the same effects and functions. Therefore, it will not be repeated here.

The apparatus according to the embodiments of the present disclosure corresponds one-to-one with the method. Therefore, the apparatus also has beneficial technical effects similar to its corresponding method. Since the beneficial technical effects of the method have been explained in detail above, the beneficial technical effects of the apparatus, equipment, and computer-readable storage medium will not be repeated here.

Through research, it has been found that most existing monitoring devices perform one-to-one signal monitoring. No single monitoring device can monitor frequency points and bands other than the target frequency point, resulting in low monitoring accuracy and signal quality, and requiring separate deployment, hence high deployment costs.

To at least partially solve one or more of the above problems and other potential problems, the present disclosure provides at least a signal processing chip and a signal monitoring system to achieve signal monitoring across all frequency bands through baseband demodulation processing, significantly improving monitoring accuracy and signal quality, requiring only simple deployment, and achieving higher integration.

To clearly explain the embodiments of the present disclosure, some concepts that may appear in subsequent embodiments will be introduced.

Digital Front End (DFE): Data interaction interface with the Radio Frequency Transceiver (TRX) chip, implementing digital In-phase/Quadrature (I/Q) data transceiver processing.

L1 Shared Memory: A shared memory that can be read and written by the RISC-V master core and also by Direct Memory Access (DMA).

RISC-V: Master Central Processing Unit (CPU) based on RISC-V.

Instruction/Data Cache (I/D Cache): RISC-V instruction cache and data cache to improve RISC-V processing efficiency.

BOOTROM: A read-only memory (ROM) where boot code is placed.

AXI4 Interconnect: An Advanced extensible Interface widely used in various processor architectures and application scenarios, with advantages such as high performance, high bandwidth, scalability, flow control, flexibility, and standardization, suitable for high-speed data transmission requirements between various components in complex System-on-Chip (SoC).

Advanced Peripheral Bus (APB): A type of peripheral bus.

Direct Memory Access (DMA): Direct memory access.

Baseband Processor: A multi-core computational cluster based on RISC-V cores, performing baseband demodulation functions.

Debug Controller: Performing chip port debugging control.

Clock Management: Implementing system clock synchronization and internal clock generation and distribution.

GPIO Controller: Used for interaction control with the TRX chip.

UART Controller: Receiving system instructions and transmits data.

Flash Controller: Controlling external Flash memory.

Low Power Controller: Controlling low-power power-saving modes.

Watchdog Timer (WDT): Implementing timing functions.

Quality of Service (QoS): Referring to the ability of a network to use various underlying technologies to provide better service capabilities for specified network communications, solving problems such as network latency and congestion.

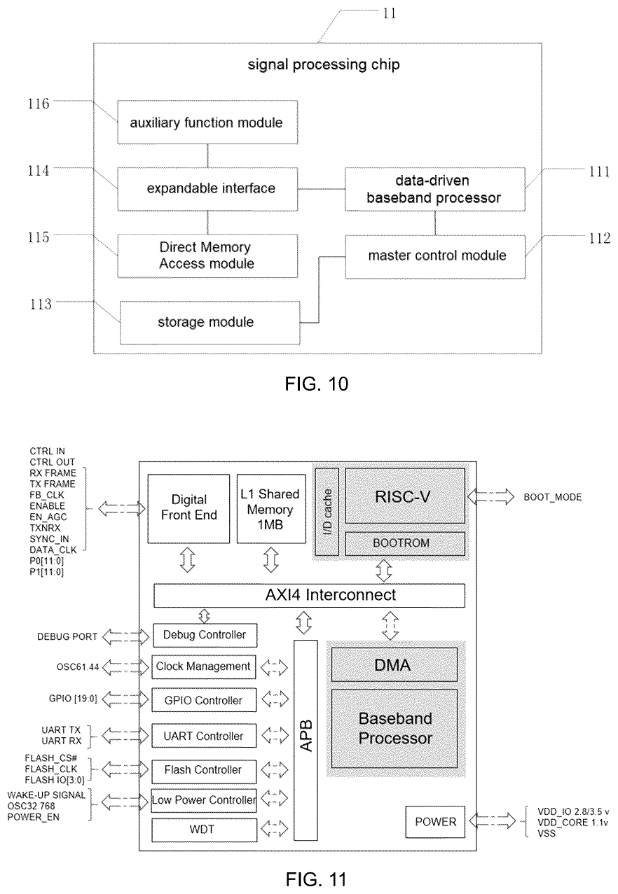

Considering the critical role of the signal processing chip in the entire signal monitoring system, the signal processing chip according to the embodiments of the present disclosure will be specifically explained next. As shown in FIG. 10, the signal processing chip 11 in the embodiments of the present disclosure mainly includes a data-driven baseband processor 111 constructed based on the RISC-V open-source architecture and a master control module 112, both.

The data-driven baseband processor 111 is configured to process baseband signals, support Time Division Duplex (TDD) synchronization, and provide an antenna address interface; and in response to a signal monitoring instruction for a signal monitoring system, receive a radio frequency (RF) signal sent by an RF transceiver, and transfer the RF signal to the master control module 112.

The master control module 112 is configured to control the start/stop of the signal processing chip 11 and obtain signal parsing status for the signal monitoring system. The signal parsing status characterizes a signal monitoring result across all frequency bands.

To facilitate understanding of the signal processing chip 11 according to the embodiments of the present disclosure, its application scenario will be briefly introduced first. Considering that most monitoring device currently used for signal quality monitoring of signal monitoring systems performs one-to-one signal monitoring, and no single monitoring device can monitor frequency points and bands other than the target frequency point, resulting in low monitoring accuracy and signal quality, and requiring separate deployment, hence high deployment costs.

Additionally, baseband signal processing usually cannot be accomplished, so there is an urgent need for monitoring device with higher integration to achieve signal monitoring across all frequency bands, using only one module/chip. This will be sufficient to adapt to the application requirements of more scenarios.

Based on this, the signal processing chip 11 according to the embodiments of the present disclosure achieves signal monitoring across all frequency bands through baseband demodulation processing, significantly improving monitoring accuracy and signal quality, requiring only simple deployment, and achieving higher integration.

In practical applications, this signal processing chip 11 may be a high-performance, especially highly integrated 4G/5G, or even 6G baseband demodulation SoC (System on Chip) based on the RISC-V (Reduced Instruction Set Computing Verilog) architecture. It monolithically integrates a Microcontroller Unit (MCU), a baseband processor, and on-chip Static RAM (SRAM), supporting a flexible and upgradable software-reconfigurable architecture.

Chip register read/write control may use the standard four-wire Serial Peripheral Interface (SPI). It adopts a 10 mm×10 mm, 100-pin Quad Flat No-leads Package (QFN). Thus, it can be widely used in 4G and 5G indoor distributed signal monitoring, repeater Time Division Duplexing (TDD) synchronization, and 5G private networks such as satellite IoT applications, with better applicability.

The data-driven baseband processor 111 here, on the one hand, can process full-band baseband signals, support TDD synchronization, and provide an antenna address interface; on the other hand, when it is determined that signal monitoring is needed, can receive the RF signal sent by the RF transceiver and perform signal parsing for the signal monitoring system through baseband demodulation of the RF signal. Specifically, the master control module 112 here can control the start/stop of the signal processing chip 11 and determine the signal parsing status used to characterize the signal monitoring result across all frequency bands.

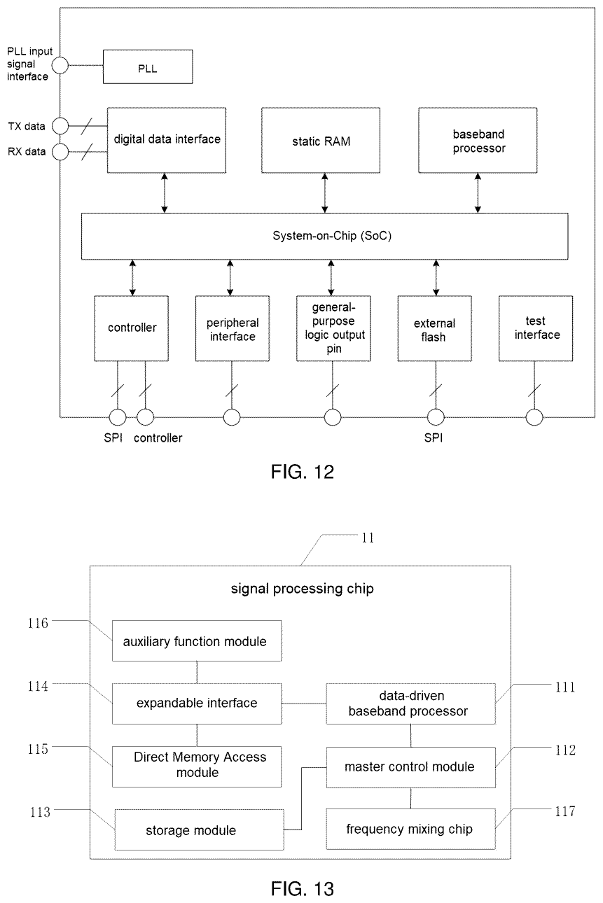

Based on the signal processing chip 11 according to the embodiments of the present disclosure, as shown in FIG. 12, the signal processing chip 11 may also have a frequency mixing chip 117 integrated in different integration forms. The frequency mixing chip 117 determines signal power obtained from user equipment and/or antenna transmission and performs mixing on the signal of the frequency band to be monitored.

In particular, this frequency mixing chip 117 specifically refers to the frequency mixing chip disclosed in the embodiments corresponding to FIGS. 1-5. By configuring the frequency mixing chip, the input signal to be frequency-shifted is converted into a frequency-shifted signal in the target frequency band, allowing the signal processing chip 11 to directly perform power detection on the frequency-shifted signal.

This chip can accomplish baseband signal processing, thereby ensuring signal transmission/reception, synchronization, demodulation, etc., for signal monitoring, fault location, and analysis.

Additionally, the data-driven baseband processor 111 built using RISC-V here and master control module 112 have better integration and stronger computational efficiency, enabling full frequency band coverage, especially for 4G-5G, and even 6G signal synchronization and monitoring. In other words, compared to the one-to-one monitoring in prior art, which lacks integration and do not support monitoring of frequency points and bands other than the target frequency point, resulting in low accuracy, the embodiments of the present disclosure achieve one-to-many monitoring, with higher integration and stronger applicability.

The signal processing chip 11 according to the embodiments of the present disclosure, on the one hand, is applicable to a base station signal source connected to the signal monitoring system to perform signal monitoring using the signal strength of the base station signal source; on the other hand, is also applicable to user equipment connected to the signal monitoring system to perform signal monitoring using the signal strength of the user equipment. This will be expanded in the following two scenarios.

First Scenario: When the RF transceiver is applied to a base station signal source connected to the signal monitoring system, the data-driven baseband processor 111 is specifically configured to: in the environment where the signal monitoring system is located, detect a base station synchronization signal, perform baseband demodulation on a first RF signal sent by the base station signal source, output a first baseband demodulated signal as well as a synchronization signal and a time slot indication signal, where the first baseband demodulated signal is used for signal parsing for the signal monitoring system, and the synchronization signal is used to achieve synchronization between the signal monitoring system and the base station signal source.

In practical applications, the signal processing chip 11 according to the embodiments of the present disclosure can perform baseband demodulation on 4G and 5G base station downlink signals, accurately detect the signal strength of indoor distributed antenna transmission, and achieve effective monitoring, automatic inspection, fault location, and intelligent analysis of 5G traditional indoor distributed antenna networks.

Second Scenario: When the RF transceiver is applied to user equipment connected to the signal monitoring system, the data-driven baseband processor 111 is specifically configured to: in the environment where the signal monitoring system is located, perform baseband demodulation on a second RF signal sent by the user equipment, and output a second baseband demodulated signal for signal parsing for the signal monitoring system.

In practical applications, the signal processing chip 11 according to the embodiments of the present disclosure also supports baseband parsing of user equipment (UE) uplink signals, enabling the determination of QoS anomalies in indoor distributed networks, user complaints, and other issues.

Furthermore, this embodiment may also be configured with multiple antennas. By determining the signal power (where the signal transmitted by each antenna is the mixed signal) obtained from the user equipment transmission with each antenna, the signal changes of the monitored mobile phone user for different antennas in the indoor distribution environment, achieving precise positioning, i.e., antenna IP (Internet Protocol) functionality, helping operators quickly and effectively locate and solve QoS problems in indoor distributed networks.

In practical applications, the signal processing chip 11 according to the embodiments of the present disclosure may be an integrated chip. This integrated chip may also have various functions integrated to adapt to more complex application scenarios.

As shown in FIG. 10, besides the RISC-V data-driven baseband processor 111 and the master control module 112, the signal processing chip 11 according to the embodiments of the present disclosure also includes a storage module 113. The storage module 113 here at least includes a shared memory accessed by the master control module 112 and other control modules, such as the L1 Shared Memory shown in FIG. 11. As a shared memory, the L1 Shared Memory may be read and written by the RISC-V master core and also by DMA.

As shown in FIG. 11, the storage module 113 in the embodiments of the present disclosure also includes an Instruction/Data Cache (I/D Cache) and a Read-Only Memory (BOOTROM) for storing boot code. The former is used for instruction and data caching to improve RISC-V processing efficiency, and the latter is for placing boot code.

As seen from FIG. 10, the signal processing chip 11 according to the embodiments of the present disclosure also includes an expandable interface 114 and a Direct Memory Access module 115 that directly performs signal communication with the expandable interface 114 to adapt to data transmission requirements in various complex scenarios.

As shown in FIG. 11, the expandable interface 114 here may be AXI4 Interconnect. As an advanced expandable interface, AXI4 is widely used in various processor architectures and application scenarios. It has advantages such as high performance, high bandwidth, scalability, flow control, flexibility, and standardization, suitable for high-speed data transmission requirements between various components in complex SoCs. In the embodiments of the present disclosure, it may perform signal communication with the data-driven baseband processor 111 (Baseband Processor). Additionally, it may be connected to Direct Memory Access (DMA) to achieve direct data transmission between peripheral devices and the storage module 113 through DMA.

As seen from FIG. 10, the expandable interface 114 in the signal processing chip 11 according to the embodiments of the present disclosure is arranged on a bus. The expandable interface performs signal communication with both the data-driven baseband processor 111 and the master control module 112. Furthermore, the auxiliary function module 116 performs signal communication with the master control module via the peripheral bus to support the control logic of the master control module 112.

The peripheral bus here may be, for example, the APB shown in FIG. 11, or other peripheral buses. The auxiliary function module 116 may be one or more of the following components:
a debug controller for port debugging (Debug Controller as shown in FIG. 11);
a clock manager for synchronizing system clocks and internal clocks (Clock Management as shown in FIG. 11);
a general-purpose input/output port controller for input/output interaction control (GPIO Controller as shown in FIG. 11);
an asynchronous serial interface controller for receiving system instructions and transmitting data (UART Controller as shown in FIG. 11);
a controller for external Flash memory control (Flash Controller as shown in FIG. 11);
a controller for enabling a low-power power-saving mode (Low Power Controller as shown in FIG. 11); and
a watchdog timer for implementing timing functions (WDT as shown in FIG. 11).

It should be noted that in practical applications, any one or any combination of the above components may be selected based on actual application requirements. There are no specific restrictions here. Additionally, other auxiliary functional components may be added to support more complex application scenarios.

To further facilitate understanding of the signal processing chip 11 according to the embodiments of the present disclosure, the signal processing chip 11 will be explained expansively with reference to its pin settings shown in FIG. 11 and the framework diagram shown in FIG. 9.

The System-on-Chip (SoC) is a high-performance, highly integrated 4G/5G baseband demodulation SoC implemented based on the RISC-V architecture. It may monolithically have a controller, peripheral interfaces, general-purpose logic output pins, external flash, test interfaces, static random access memory, digital data interfaces, phase-locked loops, and other functional modules integrated. It has higher integration, full-coverage monitoring effects, and better applicability.

The embodiments of the present disclosure also provide a signal monitoring system. As shown in FIG. 13, the signal monitoring system according to the embodiments of the present disclosure mainly includes a signal processing chip 11 for signal monitoring, a receiving antenna 22, a frequency shifter 33, a power management chip 44, and a network communication module 55. The frequency shifter 33, the signal processing chip 11, and the network communication module 55 are sequentially connected.

The frequency shifter 33 is configured to determine signal power obtained from user equipment and/or antenna 22 transmission, perform mixing on the signal of the frequency band to be monitored, and transfer the mixed signal to the signal processing chip 11.

The signal processing chip 11 is configured to, during the enabling control process of the power management chip 44, determine a signal monitoring result based on the mixed signal and transmit the signal monitoring result to the network communication module 55.

The network communication module 55 is configured to report the signal monitoring result generated by the signal processing chip 11 to the cloud.

Furthermore, the network communication module 55 here may also report antenna monitoring information of the receiving antenna 22 to the cloud.

The signal monitoring system as disclosed above, its signal processing chip 11, through the on/off control of the power management chip 44 (Power Management Unit, PMU), may implement signal monitoring for the signal monitoring system and determine the signal monitoring result across all frequency bands.

The receiving antenna 22 here may receive downlink signals from 4G and 5G base stations. Through the signal parsing of the signal processing chip 11, it can achieve effective monitoring, automatic inspection, fault location, and intelligent analysis of 4G and 5G traditional indoor distributed antenna networks, thereby filling the market gap for low-cost 4G/5G dual-mode baseband solutions. It may also receive uplink signals from user equipment (UE), solving QoS (Quality of Service) anomalies in indoor distributed networks, user complaints, and other issues. It monitors the signal changes of mobile phone users under different antennas in the indoor distribution environment, achieving precise positioning, i.e., antenna IP (Internet Protocol Address) functionality, helping operators quickly and effectively locate and solve QoS problems in indoor distributed networks.

This embodiment may be combined with the previous embodiments. For example, the frequency mixing chip 117 or frequency shifter 33 in this embodiment may adopt the frequency mixing chip of the previous embodiments, the frequency-shifting technology-based signal monitoring scheme of the previous embodiments, or the monitoring device of the previous embodiments may adopt the signal monitoring system architecture of this embodiment.

To at least partially solve one or more of the above problems and other potential problems, the present disclosure provides a signal monitoring system to achieve signal monitoring across all frequency bands, significantly improve monitoring accuracy, and reduce deployment costs.

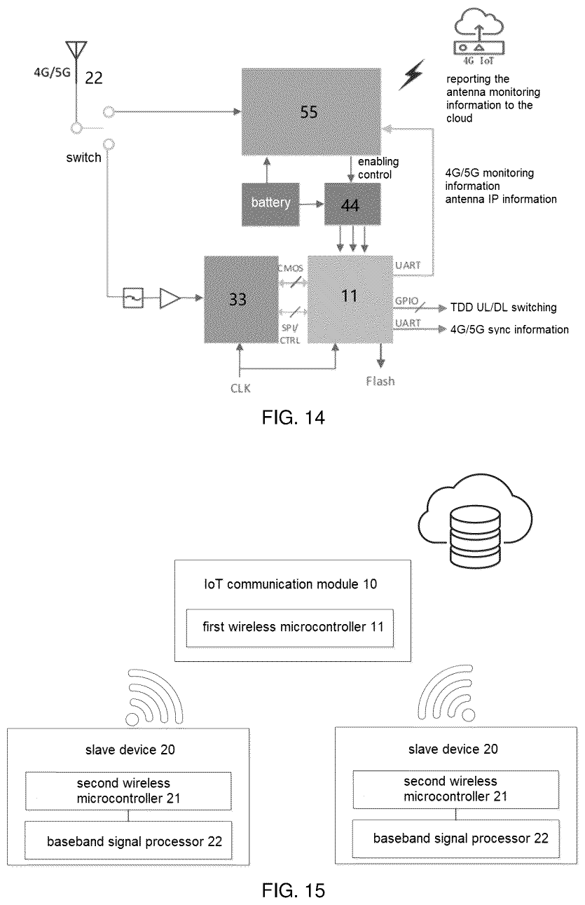

The signal monitoring system according to the embodiments of the present disclosure mainly includes an IoT communication module and one or more slave devices. FIG. 14 exemplarily shows a framework diagram of a signal monitoring system built with one IoT communication module 10 and two slave devices 20. Of course, the present disclosure is also compatible with a signal monitoring system built with one IoT communication module 10 and one slave device 20.

The IoT communication module 10 includes a first wireless microcontroller 11, and each slave device 20 includes a second wireless microcontroller 21. The slave device 20 communicates with the IoT communication module 10 via a wireless connection between the second wireless microcontroller 21 and the first wireless microcontroller 11.

The slave device 20 at least includes a baseband signal processor 22 capable of processing baseband signals, and is configured to mix an RF signal received by a frequency shifter and transfer the mixed signal to the baseband signal processor 22.

The slave device 20 is configured to, based on a signal monitoring instruction issued by the IoT communication module 10, based on an RF signal sent by user equipment or a base station signal source, determine a signal monitoring result within a frequency band indicated by the signal monitoring instruction, and transmit the signal monitoring result to the IoT communication module 10.

The IoT communication module 10 is configured to report the signal monitoring result to a cloud server.

To facilitate understanding of the signal monitoring system according to the present disclosure embodiment, its application scenario will be briefly introduced first. Considering that most monitoring device currently used for signal quality monitoring of signal monitoring systems performs one-to-one signal monitoring, and no single monitoring device can monitor frequency points and bands other than the target frequency point, resulting in low monitoring accuracy and signal quality, and requiring separate deployment, hence high deployment costs.

Based on this, the present disclosure embodiment provides a one-to-many master-slave system architecture that achieves signal monitoring across all frequency bands, significantly improving monitoring accuracy and signal quality, requiring only simple deployment, and achieving higher integration.

The IoT communication module 10 here, as a communication module between at least one slave device 20 and the cloud server, is configured to issue signal monitoring instructions to dispatch one or more slave devices 20 for signal monitoring. In other words, the IoT communication module 10 can act as the master device.

The slave device 20 at least includes a baseband signal processor 22 capable of processing baseband signals, and is configured to mix the RF signal received by the frequency shifter and transfer the mixed signal to the baseband signal processor 22. Thus, when any slave device 20 receives a signal monitoring instruction from the IoT communication module 10, it can determine the signal monitoring result within the frequency band indicated by the signal monitoring instruction based on the RF signal sent by the user equipment or the base station signal source and send it to the IoT communication module 10. The IoT communication module 10 may report the signal monitoring result to the cloud server for further signal analysis.

The baseband signal processor 22 in the present disclosure embodiment may be a high-performance, highly integrated 4G/5G, or even 6G baseband demodulation SoC (System on Chip) based on the RISC-V (Reduced Instruction Set Computing Verilog) architecture. It monolithically integrates a Microcontroller Unit (MCU), a baseband processor, and on-chip Static RAM (SRAM), supporting a flexible and upgradable software-reconfigurable architecture.

Chip register read/write control may use the standard four-wire Serial Peripheral Interface (SPI). It adopts a 10 mm×10 mm, 100-pin Quad Flat No-leads Package (QFN). Thus, it can be widely used in 4G and 5G indoor distributed signal monitoring, repeater Time Division Duplexing (TDD) synchronization, and 5G private networks such as satellite IoT applications, with better applicability.

The IoT communication module 10 includes a first wireless microcontroller (MCU) 11, and the slave device 20 includes a second wireless microcontroller 21. The slave device 20 communicates with the IoT communication module 10 via a wireless connection between the second wireless microcontroller 21 included in itself and the first wireless microcontroller 11.

In the system architecture diagram shown in FIG. 15, besides the first wireless microcontroller 11, the IoT communication module 10 also includes a first power management unit (PMU) 12 connected to the first wireless microcontroller 11, where
the first power management unit 12 is configured to place the first wireless microcontroller 11 in a powered-on startup state; and
the first wireless microcontroller 11 is configured to, in the powered-on startup state, receive the signal monitoring result sent by at least one slave device 20.

Furthermore, the IoT communication module 10 here also includes a network communication module 13 connected to the first power management unit 12 and the first wireless microcontroller 11, where
the first power management unit 12 is further configured to place the network communication module 13 in a powered-on startup state;
the first wireless microcontroller 11 is further configured to transfer the received at least one signal monitoring result to the network communication module 13; and
the network communication module 13 is configured to, in the powered-on startup state, upload the obtained at least one signal monitoring result to the cloud server.

Thus, through the communication connection between the first wireless microcontroller 11 and the second wireless microcontroller 21, the IoT communication module 10 achieves the issuance of uplink monitoring instructions and the upload of monitoring results from the slave device 20. Meanwhile, through the mutual cooperation of each slave device 20, the present disclosure embodiment achieves signal monitoring across all frequency bands, significantly improving monitoring accuracy and signal quality.

Considering the critical role of the slave device 20 in implementing signal monitoring, its specific structure will be elaborated next. As shown in the system architecture in FIG. 15, besides the baseband signal processor 22, the slave device 20 also includes a receiving antenna 23, a second power management unit 24, and a frequency shifter 25, the frequency shifter 25, the baseband signal processor 22, and the second wireless microcontroller 21 being sequentially connected, where
the frequency shifter 25 is specifically configured to determine the signal power obtained by the receiving antenna 23 receiving signals from user equipment and/or the base station signal source, perform mixing on the received RF signal, and transfer the mixed signal to the baseband signal processor 22. In some embodiments, the frequency shifter 25 performs mixing on the received RF signal by: determining the target frequency band and the target local oscillator signal used to frequency-shift the signal of frequency band under test to the target frequency band, mixing the target local oscillator signal with the signal of frequency band under test, and outputting the frequency-shifted signal for monitoring. However, this is just one example of multiple implementation methods and is not limited to this.

It should be noted that the frequency shifter may be implemented by the frequency mixing chip disclosed in the embodiments corresponding to FIGS. 1-5. By configuring the frequency mixing chip, the input signal to be frequency-shifted is converted into a frequency-shifted signal in the target frequency band, allowing the baseband signal processor 22 to directly perform power detection on the frequency-shifted signal.

The baseband signal processor 22 is specifically configured to, when the second PMU is in a powered-on enabled state, determine the signal monitoring result based on the mixed signal and transfer the signal monitoring result to the second wireless MCU.

The second wireless MCU is specifically configured to transmit the signal monitoring result generated by the baseband signal processor 22 to the IoT communication module 10.

The signal monitoring system as disclosed above, using its baseband signal processor 22 through the on/off control of the second power management chip 24, can implement signal monitoring for the signal monitoring system and determine the signal monitoring result across all frequency bands.

In certain embodiments, the receiving antenna 23 may receive downlink signals from 4G and 5G base stations. Through the signal parsing of the baseband signal processor 22, it can achieve effective monitoring, automatic inspection, fault location, and intelligent analysis of 4G and 5G traditional indoor distributed antenna networks, thereby filling the market gap for low-cost 4G/5G dual-mode baseband solutions. It may also receive uplink signals from user equipment (UE), solving QoS (Quality of Service) anomalies in indoor distributed networks, user complaints, and other issues. It monitors the signal changes of mobile phone users under different antennas in the indoor distribution environment, achieving precise positioning, i.e., antenna IP (Internet Protocol Address) functionality, helping operators quickly and effectively locate and solve QoS problems in indoor distributed networks.

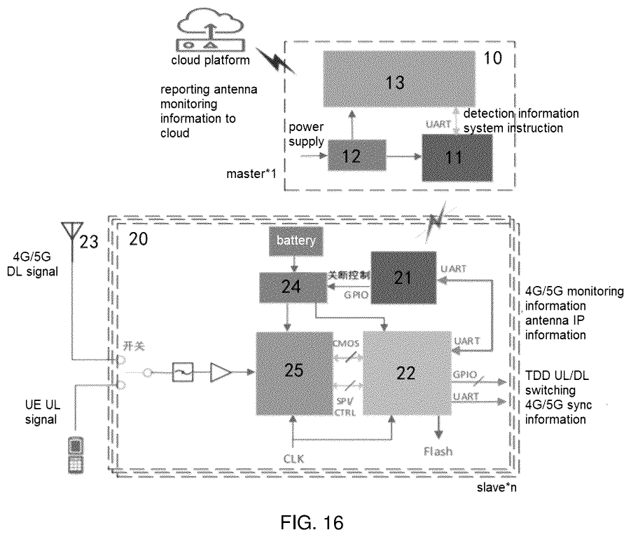

As shown in FIG. 16, the baseband signal processor 22 in the present disclosure embodiment mainly includes a data-driven baseband processor 221 constructed based on the RISC-V open-source architecture and a master control module 222, where
the data-driven baseband processor 221 is configured to process baseband signals, support Time Division Duplex (TDD) synchronization, provide an antenna address interface; in response to the signal monitoring instruction issued by the IoT communication module 10, receive the RF signal sent by the user equipment or the base station signal source, and transfer the RF signal to the master control module 222; and
the master control module 222 is configured to control the start/stop of the baseband signal processor 22 and obtain the signal monitoring result within the frequency band indicated by the signal monitoring instruction.

The data-driven baseband processor 221 built using RISC-V here and master control module 222 have better integration and stronger computational efficiency, enabling full frequency band coverage, such as various frequency bands involving 2G, 3G, 4G, 5G, and 6G, especially for 4G-5G, and even 6G signal synchronization and monitoring. In other words, compared to the one-to-one monitoring achieved by prior art, which lacks integration and do not support monitoring of frequency points and bands other than the target frequency point, resulting in low accuracy, the present disclosure embodiment achieves one-to-many monitoring, with higher integration and stronger applicability.

The baseband signal processor 22 according to the present disclosure embodiment, on the one hand, is applicable to a base station signal source connected to the signal monitoring system to perform signal monitoring using the signal strength of the base station signal source; on the other hand, is also applicable to user equipment connected to the signal monitoring system to perform signal monitoring using the signal strength of the user equipment. This will be expanded in the following two scenarios.

First Scenario: When the RF transceiver is applied to a base station signal source connected to the signal monitoring system, the data-driven baseband processor 221 is specifically configured to: in the environment where the signal monitoring system is located, detect a base station synchronization signal, perform baseband demodulation on a first RF signal sent by the base station signal source, output a first baseband demodulated signal as well as a synchronization signal and a time slot indication signal, where the first baseband demodulated signal is used for signal parsing for the signal monitoring system, and the synchronization signal is used to achieve synchronization between the signal monitoring system and the base station signal source.

In practical applications, the baseband signal processor 22 according to the present disclosure embodiment can perform baseband demodulation on 4G and 5G base station downlink signals, accurately detect the signal strength transmitted by indoor distributed antennas, and achieve effective monitoring, automatic inspection, fault location, and intelligent analysis of 5G traditional indoor distributed antenna networks.

Second Scenario: When the RF transceiver is applied to user equipment connected to the signal monitoring system, the data-driven baseband processor 221 is specifically configured to: in the environment where the signal monitoring system is located, perform baseband demodulation on a second RF signal sent by the user equipment, and output a second baseband demodulated signal for signal parsing for the signal monitoring system.

In practical applications, the baseband signal processor 22 according to the present disclosure embodiment also supports baseband parsing of user equipment (UE) uplink signals, enabling the determination of QoS anomalies in indoor distributed networks, user complaints, and other issues.

Furthermore, the present disclosure embodiment may also be configured with multiple antennas. By determining the signal power (where the signal transmitted by each antenna is the mixed signal) obtained from the user equipment transmission with each antenna, the signal changes of the monitored mobile phone user for different antennas in the indoor distribution environment, achieving precise positioning, i.e., antenna IP (Internet Protocol) functionality, helping operators quickly and effectively locate and solve QoS problems in indoor distributed networks.

In practical applications, the baseband signal processor 22 according to the present disclosure embodiment may be an integrated chip. This integrated chip may also have various functions integrated to adapt to more complex application scenarios.

As shown in FIG. 16, besides the RISC-V data-driven baseband processor 221 and the master control module 222, the baseband signal processor 22 according to the present disclosure embodiment also includes a storage module 223. The storage module 223 here at least includes a shared memory accessed by the master control module 222 and other control modules, such as the L1 Shared Memory shown in FIG. 11. As a shared memory, the L1 Shared Memory may be read and written by the RISC-V master core and also by DMA.

As shown in FIG. 11, the storage module 223 in the present disclosure embodiment also includes an Instruction/Data Cache (I/D Cache) and a Read-Only Memory (BOOTROM) for storing boot code. The former is used for instruction and data caching to improve RISC-V processing efficiency, and the latter is for placing boot code.

As seen from FIG. 16, the baseband signal processor 22 according to the present disclosure embodiment also includes an expandable interface 224 and a Direct Memory Access module 225 that directly performs signal communication with the expandable interface 224 to adapt to data transmission requirements in various complex scenarios.

As shown in FIG. 16, the expandable interface 224 here may be AXI4 Interconnect. As an advanced expandable interface, AXI4 is widely used in various processor architectures and application scenarios. It has advantages such as high performance, high bandwidth, scalability, flow control, flexibility, and standardization, suitable for high-speed data transmission requirements between various components in complex SoCs. In the present disclosure embodiment, it may perform signal communication with the data-driven baseband processor 221 (Baseband Processor). Additionally, it may be connected to Direct Memory Access (DMA) to achieve direct data transmission between peripheral devices and the storage module 223 through DMA.

As seen from FIG. 16, the expandable interface 224 in the baseband signal processor 22 according to the present disclosure embodiment is arranged on a bus. The expandable interface performs signal communication with both the data-driven baseband processor 221 and the master control module 222. Furthermore, the auxiliary function module 226 performs signal communication with the master control module 222 via the peripheral bus to support the control logic of the master control module 222.

The peripheral bus here may be, for example, the APB shown in FIG. 11, or other peripheral buses. The auxiliary function module 226 may be one or more of the following components:
a debug controller for port debugging (Debug Controller as shown in FIG. 11);
a clock manager for synchronizing system clocks and internal clocks (Clock Management as shown in FIG. 11);
a general-purpose input/output port controller for input/output interaction control (GPIO Controller as shown in FIG. 11);
an asynchronous serial interface controller for receiving system instructions and transmitting data (UART Controller as shown in FIG. 11);
a controller for external Flash memory control (Flash Controller as shown in FIG. 11);
a controller for enabling a low-power power-saving mode (Low Power Controller as shown in FIG. 11); and
a watchdog timer for implementing timing functions (WDT as shown in FIG. 11).

It should be noted that in practical applications, any one or any combination of the above components may be selected based on actual application requirements. There are no specific restrictions here. Additionally, other auxiliary functional components may be added to support more complex application scenarios.

Furthermore, the baseband signal processor 22 provided here, as shown in FIG. 16, may also integrate a frequency mixing chip 227 in different integration forms. The frequency mixing chip 227 determines signal power obtained from user equipment and/or antenna transmission and performs mixing on the signal of the frequency band to be monitored.

In practical application scenarios, the multiple slave devices 20 in the present disclosure embodiment may be arranged on nodes of a multi-level distributed network configured to determine whether a corresponding node has malfunctioned based on the signal monitoring result.

The multi-level distributed network includes a base station signal source and distributed network equipment at various levels.

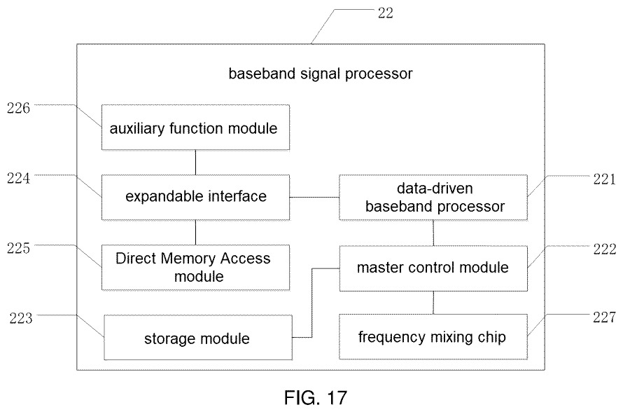

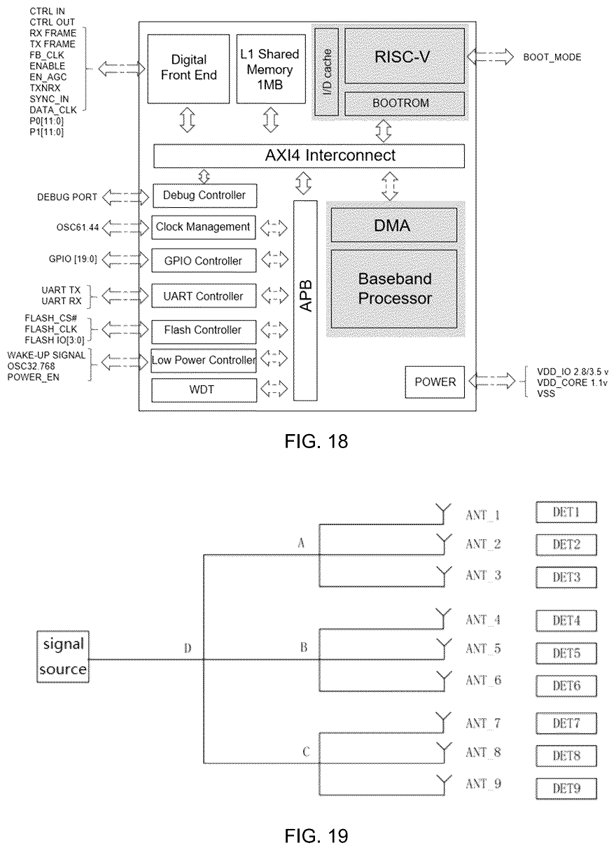

FIG. 17 shows an application diagram of the signal monitoring system according to the present disclosure embodiment on a three-level distributed network node. ANT1˜ANT9 correspond to the receiving antennas 23 of the 9 slave devices 20, and DET1˜DET9 are the 9 slave devices 20 performing signal monitoring on the corresponding nodes.

If the slave device 20 DET1 corresponding to one receiving antenna 23 ANT1 reports signal loss, then it may be confirmed that the corresponding receiving antenna 23 ANT1 has malfunctioned. Similarly, if slave devices 20 DET1/DET2/DET3 simultaneously report signal loss, but as long as not all of DET4˜DET9 report signal loss, it may be judged that node A has a problem, thus quickly locating the problematic node.

The logic for judging node B or node C is the same. When DET1˜DET9 all report signal loss, it means that either node D has malfunctioned or the base station signal source has malfunctioned.

In practical applications, these 9 slave devices 20 may be jointly deployed using only one IoT communication module 10. For example, one building/one floor only needs one IoT communication module 10 to achieve full coverage and full-band signal monitoring. The deployment is simple and the cost is lower.

In summary, according to the above signal monitoring system, the slave device included therein is configured to, based on the signal monitoring instruction issued by the IoT communication module, determine the signal monitoring result within the frequency band indicated by the signal monitoring instruction based on the RF signal sent by the user equipment or the base station signal source and perform mixing based on the target frequency band; transmit the signal monitoring result to the IoT communication module; and the IoT communication module is configured to report the signal monitoring result to the cloud server. It is evident that the present disclosure achieves signal monitoring across all frequency bands through a one-to-many master-slave system architecture, significantly improving monitoring accuracy, and reduces deployment costs.

This embodiment may be combined with the previous embodiments. For example, the baseband signal processor of the slave device in this embodiment may adopt the signal processing chip of the previous embodiments, or the signal monitoring system of the previous embodiments may adopt the signal monitoring system architecture of this embodiment.

Although the illustrative embodiments of the present disclosure have been described in detail and illustrated in the drawings and the foregoing description, they should be considered illustrative and not restrictive. It should be understood that only certain exemplary embodiments have been shown and described, and all changes and modifications that are intended to fall within the spirit of the claimed invention are protected. It should be understood that while terms such as “preferred,” “preferably,” “preferred,” or “more preferred” are used in the above description to indicate that such described features may be more desirable, they may not be essential, and embodiments without these features are contemplated to be within the scope of the present disclosure as defined by the appended claims. When reading the claims, when terms such as “a,” “an,” “at least one,” or “at least a portion” are used, it is not intended to limit the claim to one item unless specifically stated otherwise in the claim. When the language “at least a portion” and/or “a portion” is used, the item may include a portion and/or the entire item, unless specifically stated otherwise.

Although the spirit and principles of the present disclosure have been described with reference to several specific implementations, it should be understood that the present disclosure is not limited to the disclosed specific implementations, and the division of aspects does not mean that the features in these aspects cannot be combined. The present disclosure is intended to cover various modifications and equivalent arrangements included within the spirit and scope of the appended claims.

What is claimed is:

1. A frequency mixing chip comprising an internal local oscillator, a multiplexer, and a mixer, wherein
the internal local oscillator is configured to generate a first local oscillator signal based on a reference clock signal;
the multiplexer has a first input terminal for receiving a second local oscillator signal, a second input terminal for receiving the first local oscillator signal, and an output terminal for outputting a mixing signal;
the mixer is configured to mix a signal to be frequency-shifted with the mixing signal, thereby generating a frequency-shifted signal for signal power monitoring.

2. The frequency mixing chip of claim 1, wherein the mixer is configured as a dual-channel mixer comprising a first mixer and a second mixer, wherein
the first mixer has a first input terminal for receiving the signal to be frequency-shifted, a second input terminal for receiving the mixing signal, and an output terminal for outputting the frequency-shifted signal; and
the second mixer has a first input terminal for receiving the signal to be frequency-shifted, a second input terminal for receiving the mixing signal, and an output terminal for outputting the frequency-shifted signal.

3. The frequency mixing chip of claim 2, wherein the dual-channel mixer further comprises a first amplifier and a second amplifier, wherein
the first amplifier has a first terminal connected to a first output terminal of the multiplexer, and a second terminal connected to the second input terminal of the first mixer; and
the second amplifier has a first terminal connected to a second output terminal of the multiplexer, and a second terminal connected to the second input terminal of the second mixer.

4. A monitoring device having a frequency mixing chip of claim 1 integrated therein, wherein the frequency mixing chip has an output terminal connected to an input terminal of a power detection apparatus of the monitoring device.

5. A signal monitoring method based on frequency-shifting, comprising:
receiving a signal of frequency band under test;
determining a target frequency band and a target local oscillator signal based on an interference metric of a mixed signal generated from an interference frequency band signal and the target local oscillator signal relative to the target frequency band;
outputting a frequency-shifted signal within the target frequency band by mixing the target local oscillator signal with the signal of frequency band under test; and
monitoring the frequency-shifted signal.

6. The signal monitoring method of claim 5, further comprising making the interference metric below a preset threshold.

7. The signal monitoring method of claim 5, wherein determining the target frequency band and the target local oscillator signal based on the interference metric comprises making the mixed signal generated from the interference frequency band signal and the target local oscillator signal fall outside the target frequency band.

8. The signal monitoring method of claim 5, wherein determining the target frequency band and the target local oscillator signal based on the interference metric comprises:
determining the target frequency band;
determining a plurality of candidate local oscillator frequency points capable of frequency-shifting the signal of frequency band under test to the target frequency band;
determining a mixed signal generated from the interference frequency band signal and a local oscillator signal corresponding to each candidate local oscillator frequency point;
determining a corresponding interference metric by determining a proportion of the mixed signal corresponding to each candidate local oscillator frequency point falling into the target frequency band;
determining the target local oscillator signal based on the interference metric corresponding to each candidate local oscillator frequency point.

9. The signal monitoring method of claim 8, further comprising determining a local oscillator signal corresponding to a candidate local oscillator frequency point with a lowest interference metric and/or with an interference metric below a preset threshold as the target local oscillator signal.

10. The signal monitoring method of claim 6, wherein determining the interference metric comprises:
calculating according to a preset formula, FL=m*LO+n*RF, a frequency range where the interference frequency band signal resides after frequency-shifting; and
determining the interference metric by comparing the frequency range with the target frequency band,
wherein RF denotes a frequency of the interference frequency band signal, LO denotes a frequency point of the local oscillator signal for frequency-shifting, m denotes a variable positive integer value, n denotes a variable integer value, and FL denotes a frequency of the frequency-shifted interference frequency band signal.

11. The signal monitoring method of claim 5, wherein the interference frequency band signal falls within any one or more of: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s), and the frequency band under test comprises any one or more of: 3G frequency band and/or its harmonic frequency band(s), 4G frequency band and/or its harmonic frequency band(s), 5G frequency band and/or its harmonic frequency band(s), and WiFi frequency band and/or its harmonic frequency band(s).

12. A signal monitoring apparatus based on frequency-shifting, for implementation of a signal monitoring method of claim 5, the signal monitoring apparatus comprising:
a receiving module configured to receive a signal of frequency band under test;
a control module configured to determine a target frequency band and a target local oscillator signal based on an interference metric of a mixed signal generated from an interference frequency band signal and the target local oscillator signal relative to the target frequency band;
a frequency-shifting module configured to output a frequency-shifted signal within the target frequency band by mixing the target local oscillator signal with the signal of frequency band under test; and
a monitoring module configured to monitor the frequency-shifted signal.

13. A signal processing chip comprising a data-driven baseband processor and a master control module, the data-driven baseband processor being constructed based on a Reduced Instruction Set Computing Verilog (RISC-V) open-source architecture, wherein
the data-driven baseband processor is configured to: process baseband signals, support Time Division Duplex (TDD) synchronization, provide an antenna address interface; and in response to a signal monitoring instruction for a signal monitoring system, receive a radio frequency (RF) signal sent by an RF transceiver, and transfer the RF signal to the master control module; and
the master control module is configured to control start/stop of the signal processing chip and obtain signal parsing status for the signal monitoring system, the signal parsing status characterizing a signal monitoring result across all frequency bands,
wherein when configured with a plurality of antennas, the signal processing chip further comprises the frequency mixing chip of claim 1 configured to determine signal power obtained from user equipment and/or antenna transmission, perform mixing on a signal of frequency band to be monitored, and output the mixed signal to the master control module.

14. The signal processing chip of claim 13, wherein when the RF transceiver is applied to a base station signal source connected to the signal monitoring system, the data-driven baseband processor is configured to:
detect, in an environment where the signal monitoring system is located, a base station synchronization signal, perform baseband demodulation on a first RF signal sent by the base station signal source, and output a first baseband demodulated signal as well as a synchronization signal and a time slot indication signal.

15. The signal processing chip of claim 13, wherein when the RF transceiver is applied to a user equipment connected to the signal monitoring system, the data-driven baseband processor is configured to:
perform, in the environment where the signal monitoring system is located, baseband demodulation on a second RF signal sent by the user equipment, and output a second baseband demodulated signal for performing signal parsing for the signal monitoring system.

16. A signal monitoring system comprising an Internet of Things (IoT) communication module, and one or more slave devices, the IoT communication module including a first wireless microcontroller (MCU), and each slave device including a second wireless MCU and communicating with the IoT communication module via a wireless connection between the second wireless MCU and the first wireless MCU, wherein
the slave device comprises a baseband signal processor capable of processing baseband signals, and is configured to perform mixing on an RF signal received by a frequency shifter and transfer the mixed signal to the baseband signal processor;
the slave device is configured to, in response to a signal monitoring instruction issued by the IoT communication module, based on an RF signal sent by user equipment or a base station signal source, determine a signal monitoring result within a frequency band indicated by the signal monitoring instruction, and transmit the signal monitoring result to the IoT communication module; and
the IoT communication module is configured to report the signal monitoring result to a cloud server.

17. The signal monitoring system of claim 16, wherein the IoT communication module further comprises a first power management unit (PMU) connected to the first wireless MCU, wherein
the first PMU is configured to place the first wireless MCU in a powered-on startup state; and
the first wireless MCU is configured to, in the powered-on startup state, receive the signal monitoring result sent by at least one of the slave devices.

18. The signal monitoring system of claim 17, wherein the IoT communication module further comprises a network communication module connected to the first PMU and the first wireless MCU, wherein
the first PMU is further configured to place the network communication module in a powered-on startup state;
the first wireless MCU is further configured to transmit the received at least one signal monitoring result to the network communication module; and
the network communication module is configured to, in the powered-on startup state, upload the obtained at least one signal monitoring result to the cloud server.

19. The signal monitoring system of claim 16, wherein the slave device further comprises a receiving antenna, a second power management unit (PMU), and the frequency shifter, the frequency shifter, the baseband signal processor, and the second wireless MCU being sequentially connected, wherein
the frequency shifter is configured to determine signal power obtained by the receiving antenna receiving signals from user equipment and/or the base station signal source, perform mixing on the received RF signal, and transfer the mixed signal to the baseband signal processor;
the baseband signal processor is specifically configured to, when the second PMU is in a powered-on enabled state, determine the signal monitoring result based on the mixed signal, and transmit the signal monitoring result to the second wireless MCU; and
the second wireless MCU is specifically configured to transmit the signal monitoring result generated by the baseband signal processor to the IoT communication module.

20. The signal monitoring system of claim 16, wherein the plurality of slave devices are disposed on nodes of a multi-level distributed network, and configured to determine whether a corresponding node has malfunctioned based on the signal monitoring result.
